(19) United States
(12) Patent Application Publication
(10) Pub. No.: US 2025/0117198 A1
(43) Pub. Date: Apr. 10, 2025

(54) METHODS AND SYSTEMS OF FACILITATING PROVISIONING OF A SOFTWARE FUNCTIONALITY

(71) Applicant: Linvest21, Inc., Tuxedo Park, NY (US)

(72) Inventors: David Dong Lin, Tuxedo Park, NY (US); Yunfan Ma, Tuxedo Park, NY (US)

(21) Appl. No.: 18/907,021

(22) Filed: Oct. 4, 2024

Related U.S. Application Data
(60) Provisional application No. 63/587,930, filed on Oct. 4, 2023.

(51) Int. Cl. G06F 8/35

(52) U.S. Cl. CPC G06F 8/35

(57) ABSTRACT

The present disclosure provides a method of facilitating provisioning of a software functionality. Further, the method may include receiving, using a communication device, an input data from a user device. Further, the method may include generating, using a processing device, an output data based on the input data and a first LLM. Further, the first LLM may be trained on training data corresponding to the software functionality. Further, the training data includes an input training data and an output training data. Further, the output training data may be generated by an implementation of the software functionality based on the input training data. Further, the method may include transmitting, using the communication device, the output data.

### FIELD OF DISCLOSURE

Generally, the present disclosure relates to the field of data processing. More specifically, the present disclosure relates to methods, systems, apparatuses, and devices for facilitating provisioning of a software functionality.

### BACKGROUND

In the realm of classical software development, producing and maintaining enterprise solutions often requires intricate designs spanning multiple tiers, encompassing front-end, back-end, and database components. Such development processes are resource-intensive, both in terms of time and financial investment. With the emergence of artificial intelligence and, more specifically, Large Language Models (LLMs), there exists an opportunity to revolutionize this traditional approach. LLMs, with their expansive knowledge and capability to generate human-like text, present a promising alternative. However, until now the use of LLMs have been limited to support software development activity by way of generating software artifacts. Additionally, most software development are generic in nature and do not incorporate domain specific information adequately.

Therefore, there is a need for improved methods and systems for facilitating rendering software solutions using transformative large language platforms that may overcome one or more of the above-mentioned problems and/or limitations.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method of facilitating provisioning of a software functionality. Further, the method may include receiving, using a communication device, an input data from a user device. Further, the method may include generating, using a processing device, an output data based on the input data and a first LLM. Further, the first LLM may be trained on training data corresponding to the software functionality. Further, the training data includes an input training data and an output training data. Further, the output training data may be generated by an implementation of the software functionality based on the input training data. Further, the method may include transmitting, using the communication device, the output data.

The present disclosure provides a system for facilitating provisioning of a software functionality. Further, the system may include a communication device. Further, the communication device may be configured to receive an input data from a user device. Further, the communication device may be configured to transmit an output data. Further, the system may include a processing device communicatively coupled with the communication device. Further, the processing device may be configured to generate the output data based on the input data and a first LLM. Further, the first LLM may be trained on training data corresponding to the software functionality. Further, the training data includes an input training data and an output training data. Further, the output training data may be generated by an implementation of the software functionality based on the input training data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating provisioning of a software functionality, in accordance with some embodiments.

FIG. 4 illustrates a flowchart of a method 400 of facilitating provisioning of a software functionality including generating, using the processing device 604, a prompt, in accordance with some embodiments.

FIG. 5 illustrates a flowchart of a method 500 of facilitating provisioning of a software functionality including generating, using the processing device 604, a prompt data, in accordance with some embodiments.

FIG. 6 illustrates a block diagram of a system 600 of facilitating provisioning of a software functionality, in accordance with some embodiments.

FIG. 7 illustrates a block diagram of the system 600 of facilitating provisioning of a software functionality, in accordance with some embodiments.

FIG. 8 is a flowchart of a method 800 for facilitating rendering software solutions using transformative large language platforms, in accordance with some embodiments.

FIG. 9 is a continuation of a flowchart of a method 800 for facilitating rendering software solutions using transformative large language platforms, in accordance with some embodiments.

FIG. 10 is a block diagram of a system 1000 for facilitating rendering software solutions using transformative large language platforms, in accordance with some embodiments.

FIG. 11 is a flowchart of a method 1100 for facilitating rendering software solutions using transformative large language models, in accordance with some embodiments.

FIG. 12 illustrates a training and fine-tuning of an LLM model 1202 on domain data, in accordance with some embodiments.

FIG. 13 illustrates a training and fine-tuning of the LLM model 1202 on domain computation logic, in accordance with some embodiments.

FIG. 14 illustrates a post-training of the LLM model 1202, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

### Definitions and Key Terminology

Prompt Language/Model: A Prompt Language or Model refers to a method or mechanism by which users can guide the output of a language model. In the context of language models, a prompt is an input text string that instructs the model to generate a specific type of response. For example, if given the prompt “Translate the following English text to French:” the model would anticipate a subsequent English sentence and provide its French translation. The prompt essentially instructs the model on the desired task.

Embedding: In machine learning, especially in the context of natural language processing, an embedding is a representation of data in a reduced-dimensional space. For textual data, word embeddings are dense vector representations where words with similar meanings tend to have vectors that are close to each other in the vector space. Embeddings are used to capture semantic relationships between words or phrases and are commonly used in deep learning models to transform high-dimensional data (like text) into a more manageable format for processing.

LLM (Large Language Model): A Large Language Model refers to a type of artificial intelligence model, specifically a deep learning model that is designed to understand and generate humanlike text based on the input LLM receives. These models are trained on vast amounts of text data, allowing them to generate coherent and contextually relevant sentences, paragraphs, or even longer text structures. They can perform a variety of tasks, from simple text completion to answering questions, translation, and more.

Domain-Specific Prompt Model: A Domain-Specific Prompt Model refers to a specialized adaptation of a general-purpose language model that is optimized for a specific domain or industry. By training or adapting the model using data or prompts from a particular field, the model becomes more adept at generating and understanding content specific to that domain. This is especially useful when there's a need for expertise or nuanced understanding within specific areas, such as finance, medicine, law, or engineering. The tailored prompts guide the model to produce outputs that are more aligned with the expectations and terminologies of the specific domain.

Domain-Specific Embedding: Domain-Specific Embedding refers to the representation of data in a reduced dimensional space that is specifically optimized or tailored for a particular domain, industry, or context. Unlike generic embeddings that aim to capture general semantic relationships in a broad dataset, domain-specific embeddings are trained or fine-tuned using data pertinent to a specific domain. This ensures that the embeddings capture the nuances, terminologies, and relationships unique to that domain. For instance, embeddings tailored for the medical domain would give closer vector representations for terms like “cardiology” and “angioplasty” compared to generic embeddings. The goal of domain-specific embedding is to enhance the model's performance and understanding in tasks related to that specific domain.

Fine-tuning of LLM (Large Language Model): Fine-tuning refers to the process of taking a pre-trained language model (like an LLM) and further training the LLM on a smaller, domain-specific dataset. The purpose of fine-tuning is to adapt the general knowledge and capabilities of the large model to the nuances and specificities of a particular domain or task without training a model from scratch. During fine-tuning, the weights of the model are adjusted to minimize the error on the new, specific dataset, allowing the model to produce more accurate and relevant outputs for that domain or task.

The present disclosure describes methods and systems for facilitating rendering software solutions using transformative large language platforms. The disclosed methods and systems relate to the field of artificial intelligence, specifically to the use of Large Language Models (or LLMs) as the platforms for enterprise software solutions within a given domain or industry vertical. The present disclosure introduces the concept of domain-specific prompt model, embedding, and LLM fine-tuning, “trained” and “built” by domain-specific data, compute logic, and workflow. Further, the method focuses on the use of LLMs trained or fine-tuned for specific domains and is enhanced with domain-specific embedding. This unique embedding approach ensures a holistic solution adaptable to various industry needs, covering Data, Compute Logic, and Workflow comprehensively.

Classical Software Development aims to produce front-end, back-end, and database in 3 to N-tier design for enterprise. In this setup, the design, development, and maintenance of the back-end and database are the most complex and costly in time and financial resource processes. The present disclosed system seeks to revolutionize this classical Software Development process, by training and/or fine-tuning public and/or proprietary Large Language Models (LLM) as the back-end and database themselves, vs manually build out these components in traditional development. These training and fine-tuning are broadly categorized into 2 types on a continuous basis-“Computational Logics” and “Data”.

Further, the method may propose a transformative approach, leveraging Large Language Models (LLMs) trained or fine-tuned specifically for domain-centric tasks, effectively serving as both the back-end and database. These LLMs undergo continuous training and fine-tuning, emphasizing two primary categories: “Computational Logic” and “Data”.

Domain-specific Training and Fine-tuning of LLMs involves two concepts including: 1) The training and fine-tuning of “Data”—refer to the process of building out extensive training data on “Domain Data” in for various topical areas of a specific Industry Domain (for instance—Financial Service or Healthcare Industry) to train and fine-tuning specific LLMs. For illustration purposes, these topical areas of “Domain Data” in Investment Management refer to: Security Master, Investment Book of Record, Market Data, Reference Data, etc. This topical Data not only includes domain-specific information, but also data such as authentication and authorization, therefore the LLM-based system can be security and privacy aware, and control access appropriately when servicing requests. In addition, the training around access control reflects regulatory rules, regulations, and best practices per the guidance of relevant governmental agencies. 2) The training and fine-tuning of “Computational Logics”-refer to a minimum of 3 sub-processes: a. Building out extensive training data in “computational logic” for various topical areas of a specific Industry Domain (for instance—Financial Service or Healthcare Industry) to train and fine-tune chosen LLMs. b. Training Computational logic to use afore-mentioned “Data” in the LLMs. c. Establishment of unique “prompt” language for the models, so that different “Computational Capability” of the trained or fine-tuned LLMs can be targeted effectively with stability.

Data Embedding and LLM Fine-tuning: The data embedding and LLM fine-tuning comprises two steps: 1) Data Embedding: This process focuses on transforming domain-specific data into embeddings. These vector representations capture the semantic relationships and nuances of terms and concepts within the industry, enabling the LLM to interact effectively with industry-specific terminologies and information; 2) LLM Fine-tuning with Embedded Data: Once embeddings are generated, they play a pivotal role in the fine-tuning process. The LLM is trained using this embedded data, ensuring the LLM grasps the intricacies and relationships inherent in the domain-specific data, producing contextually relevant and accurate responses.

Computational Logics, Workflow Embedding, and LLM Fine-tuning: Computational Logics, Workflow Embedding, and LLM Fine-tuning comprises 3 steps: 1) Computational Logics Embedding: This focuses on creating vector representations of computational logic patterns relevant to a specific industry domain, ensuring the LLM may generate intricate logic patterns essential for the domain; 2) Workflow Embedding: Transforming workflows into embeddings provides the LLM insights into the optimal sequence of operations, decision points, and interdependencies within the industry, ensuring the LLM may generate or suggest workflows adhering to industry best practices; 3) LLM Fine-tuning with Embedded Computational Logics and Workflows: Integrating both computational logic and workflow embeddings into the LLM training process amplifies its capabilities, resulting in an LLM that understands both the computational logic and industry-specific workflows.

### Examples and Illustrations (Using Investment Management Industry as Case in Point):

Service API for OTC Bonds: Security createNewOTCBond(SecurityAnalytics inputSecurityAnalytics); Descriptive note: The LLMaaP comprehends the intricacies of over-the-counter (OTC) bonds, including the workflows and computational logic. Moreover, the LLM is aware of user access entitlements related to these functionalities and underlying data.

Service API for Exchange-Traded Bonds: Security createNewExchangeTradedBond(SecurityAnalytics inputSecurityAnalytics); Descriptive note: This contrasts with the previous example by highlighting the LLMaaP's understanding of exchange-traded bonds. The LLMaaP recognizes the distinctions between OTC and exchange-traded bonds, ensuring appropriate workflows and computations are applied.

Domain-Specific Prompt Model as API: One of the cornerstones of the disclosed system is the establishment of a unique “prompt” language tailored for the trained or fine-tuned LLMs. This domain-specific prompt model serves as a specialized API, enabling precise targeting of the LLM's computational capabilities.

Key characteristics of this “prompt” language include: 1) Rich Semantic Constructs: The prompt language is rich in semantic constructs and meaning, capable of describing various scenarios, needs, and capabilities. This richness ensures that intricate domain-specific requests are comprehended and processed accurately by the LLM; 2) Domain Expertise: Embedded within the prompt language is a deep understanding of domain concepts, computational logic, and data usage. For instance, within the financial sector, the prompt language possesses a nuanced understanding of various financial instruments, characteristics, and related actionable features. The prompt language ensures that domain-specific inquiries are addressed with a high degree of precision; 3) Stability in Interpretation: One of the primary goals during the establishment of the prompt language is to ensure stability. This means that for a given prompt, the LLM's output remains consistent across multiple inquiries. This stability ensures reliability, especially critical for enterprise solutions where predictability in responses is paramount.

Usage of the Post Training and Fine-tuning LLMs as Platforms: The refined LLMs, once trained and fine-tuned, serve as robust platforms providing service endpoints, also known as Application Program Interfaces (APIs). These APIs allow interaction with externally developed front-ends or any client-side programs, establishing a seamless end-to-end platform. The domain-specific prompt model plays a pivotal role in this interaction. In a novel approach, designs created in tools like “Figma” may be paired with Domain-Specific Embeddings and LLMs to auto-generate UI components. This not only speeds up the UI design and development process but also ensures that the interface is contextually aligned with the underlying data and logic. Further, users interact with the system through the UI, issuing service calls imbued with the appropriate “prompt” language. The LLMaaP, recognizing the domain-specific prompts, determines the appropriate access, processes the prompt, and provides structured resulting data. The front-end UI then processes this data, rendering the relevant screen elements for end-users, and ensuring a cohesive user experience.

Training Techniques: Several methodologies exist for the aforementioned training processes including: a) holistic approach might involve a fine-tuning advanced public LLMs with domain-specific data to create appropriately formatted training datasets; b) Utilizing industry-standard data sources for domain data training; c). Establishing client-friendly access-control datasets adhering to regulatory requirements; d). Designing proprietary computational logic workflows with relevant code, design patterns, and technical stacks to serve as training data; e). Implementing a “Training Data Reviewer”, leveraging advanced LLMs to review iterative training data for both content and format accuracy.

Transformative Nature of the LLMaaP: While the usage of LLMs as service providers isn't novel, the intentional training and fine-tuning for specific domains, combined with precise service delivery and fine-grained entitlement, is ground-breaking. The disclosed system addresses the challenges associated with the unpredictable nature of LLMs, making them suitable for comprehensive enterprise back-end solutions.

Continuous adaptability: The nature of continuous training and fine-tuning (for the LLMaaP), the platform is designed to be adaptive and flexible to the changing nature of end-client needs. For example: User A changes role from “Equity Portfolio Manager” (of Account 1234) to “Equity Researcher”, the (continuous) “Entitlement Data” for training may reflect the change, therefore ensuring the LLMaaP may prohibit User A from accessing Account 1234 from the time of change. In Equity Portfolio Management, there is a change in Tracking Error calculation from “return-based” to “holding-based” logic. The (continuous) “Computational Logic” training Data may reflect this change. As a result, the LLMaaP may change the underlying meaning of Tracking Error when inquired.

Scope of Usage: The LLMaaP has the potential to revolutionize the software development industry. Its versatility allows the LLM to cater to diverse sectors, from Financial Services and Medical to Education and Government agencies, underscoring its universal applicability.

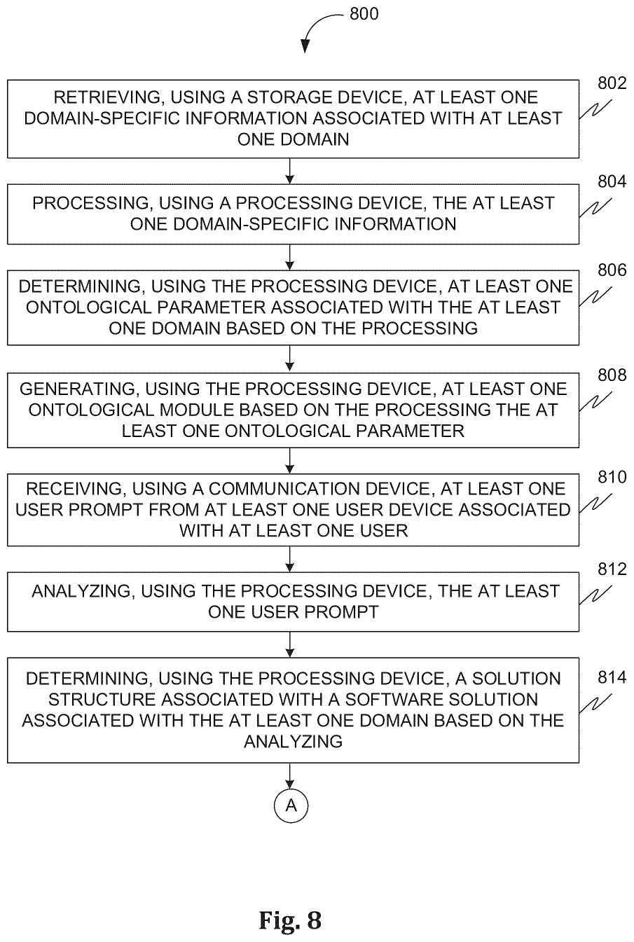

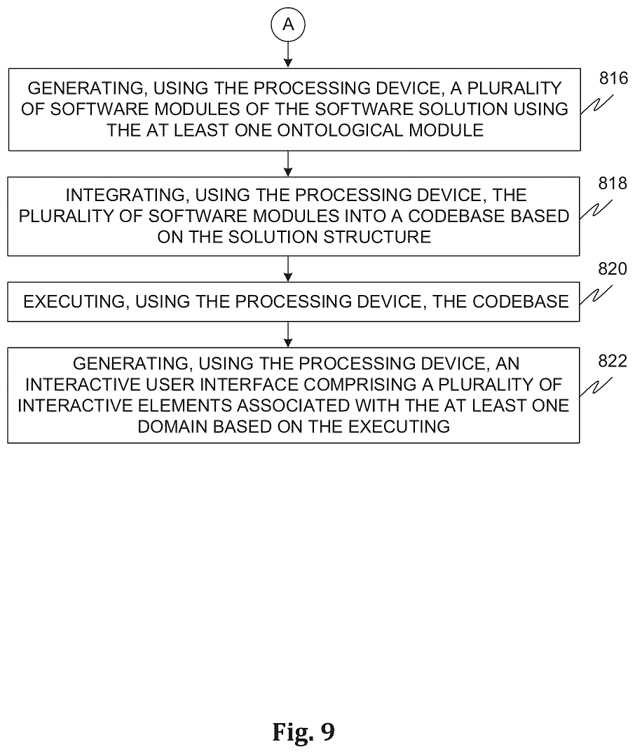

FIG. 8 and FIG. 9 are a flowchart of a method 800 for facilitating rendering software solutions using transformative large language platforms, in accordance with some embodiments.

Further, the method 800 may include a step 802 of retrieving, using a storage device 1006, at least one domain-specific information associated with at least one domain. Further, the at least one domain may include, but may not be limited to finance, medical, engineering, etc.

Further, the method 800 may include a step 804 of processing, using a processing device 1004, the at least one domain-specific information.

Further, the method 800 may include a step 806 of determining, using the processing device 1004, at least one ontological parameter associated with the at least one domain based on the processing.

Further, the method 800 may include a step 808 of generating, using the processing device 1004, at least one ontological module based on the processing of the at least one ontological parameter.

Further, the method 800 may include a step 810 of receiving, using a communication device 1002, at least one user prompt from at least one user device associated with at least one user. Further, the at least one user device may include, but may not be limited to, a smartphone, a laptop, a desktop, a tablet computer, etc.

Further, the method 800 may include a step 812 of analyzing, using the processing device 1004, the at least one user prompt.

Further, the method 800 may include a step 814 of determining, using the processing device 1004, a solution structure associated with a software solution associated with the at least one domain based on the analyzing.

Further, the method 800 may include a step 816 of generating, using the processing device 1004, a plurality of software modules of the software solution using the at least one ontological module. Further, the plurality of modules may include, but may not be limited to, at least one front-end aspect and at least one back-end aspect of the software solution.

Further, the method 800 may include a step 818 of integrating, using the processing device 1004, the plurality of software modules into a codebase based on the solution structure.

Further, the method 800 may include a step 820 of executing, using the processing device 1004, the codebase.

Further, the method 800 may include a step 822 of generating, using the processing device 1004, an interactive user interface comprising a plurality of interactive elements associated with the at least one domain based on the executing. Further, the plurality of interactive elements may allow the at least one user to interact with the interactive user interface.

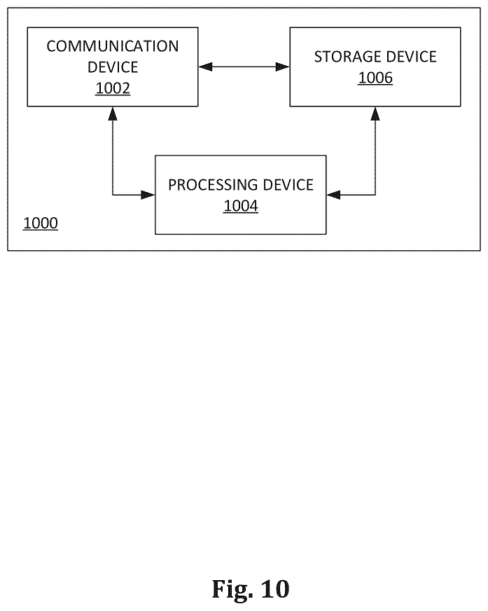

FIG. 10 is a block diagram of a system 1000 for facilitating rendering software solutions using transformative large language platforms, in accordance with some embodiments. Accordingly, the system 1000 may include a processing device 1004, a communication device 1002, and a storage device 1006. Further, the communication device 1002 may be communicatively coupled with the processing device 1004. Further, the communication device 1002 may be communicatively coupled with the storage device 1006. Further, the storage device 1006 may be communicatively coupled with the processing device 1004.

Further, the processing device 1004 may be configured for receiving at least one user prompt from at least one user device associated with at least one user. Further, the at least one user device may include, but may not be limited to, a smartphone, a laptop, a desktop, a tablet computer, etc.

Further, the processing device 1004 may be configured for processing at least one domain-specific information. Further, the processing device 1004 may be configured for determining at least one ontological parameter associated with the at least one domain based on the processing. Further, the processing device 1004 may be configured for generating at least one ontological module based on the processing the at least one ontological parameter. Further, the processing device 1004 may be configured for analyzing the at least one user prompt. Further, the processing device 1004 may be configured for determining a solution structure associated with a software solution associated with the at least one domain based on the analyzing. Further, the processing device 1004 may be configured for generating a plurality of software modules of the software solution using the at least one ontological module. Further, the plurality of modules may include, but may not be limited to, at least one front-end aspect and at least one back-end aspect of the software solution. Further, the processing device 1004 may be configured for integrating the plurality of software modules into a codebase based on the solution structure. Further, the processing device 1004 may be configured for executing the codebase. Further, the processing device 1004 may be configured for generating an interactive user interface comprising a plurality of interactive elements associated with the at least one domain based on the executing. Further, the plurality of interactive elements may allow the at least one user to interact with the interactive user interface.

Further, the storage device 1006 may be configured for retrieving, using a storage device 1006, the at least one domain-specific information associated with at least one domain. Further, the at least one domain may include, but may not be limited to finance, medical, engineering, etc.

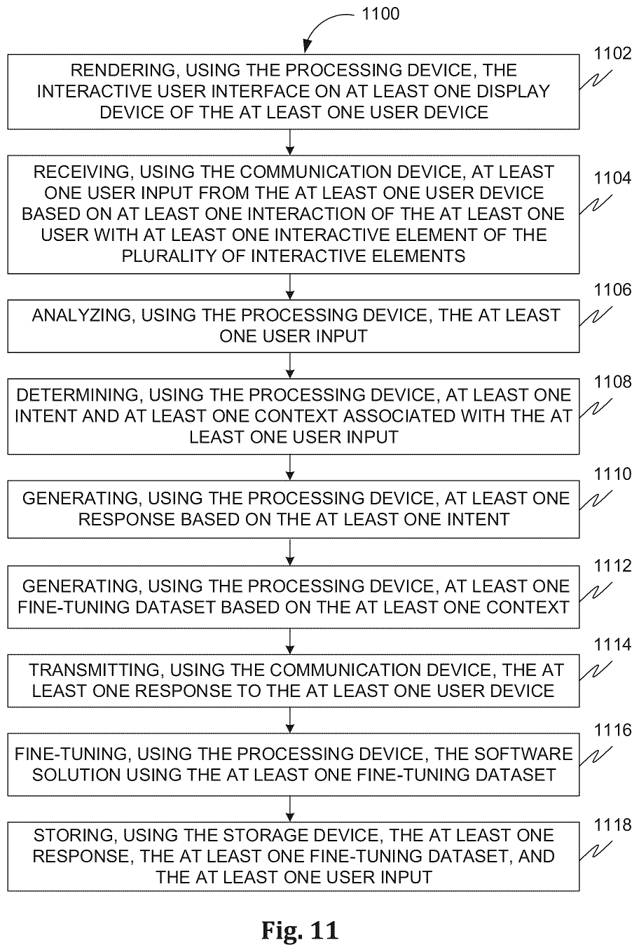

FIG. 11 is a flowchart of a method 1100 for facilitating rendering software solutions using transformative large language models, in accordance with some embodiments.

Further, the method 1100 may include a step 1102 of rendering, using the processing device 1004, the interactive user interface on at least one display device of the at least one user device.

Further, the method 1100 may include a step 1104 of receiving, using the communication device 1002, at least one user input from the at least one user device based on at least one interaction of the at least one user with at least one interactive element of the plurality of interactive elements.

Further, the method 1100 may include a step 1106 of analyzing, using the processing device 1004, the at least one user input.

Further, the method 1100 may include a step 1108 of determining, using the processing device 1004, at least one intent and at least one context associated with the at least one user input.

Further, the method 1100 may include a step 1110 of generating, using the processing device 1004, at least one response based on the at least one intent.

Further, the method 1100 may include a step 1112 of generating, using the processing device 1004, at least one fine-tuning dataset based on the at least one context.

Further, the method 1100 may include a step 1114 of transmitting, using the communication device 1002, the at least one response to the at least one user device.

Further, the method 1100 may include a step 1116 of fine-tuning, using the processing device 1004, the software solution using the at least one fine-tuning dataset.

Further, the method 1100 may include a step 1118 of storing, using the storage device 1006, the at least one response, the at least one fine-tuning dataset, and the at least one user input.

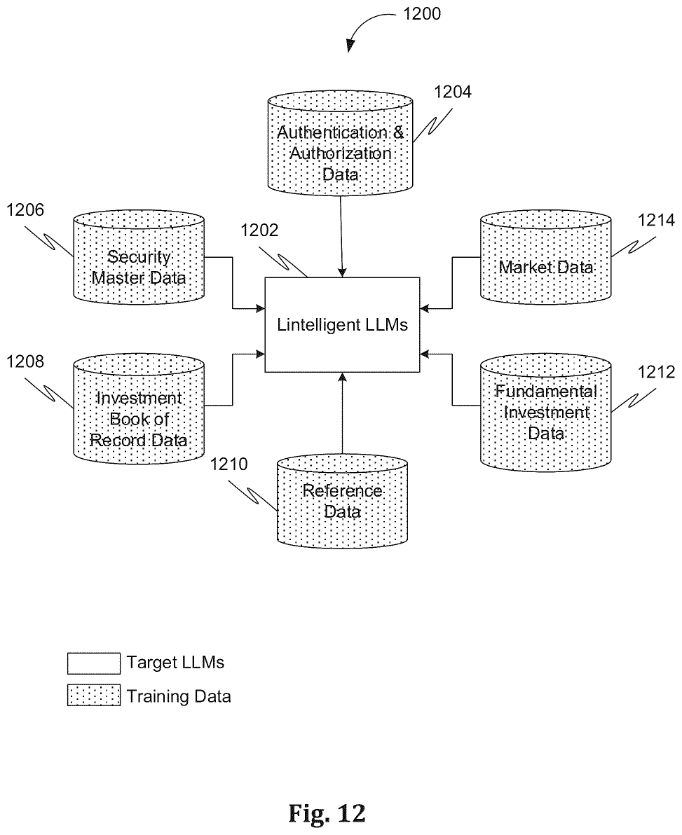

FIG. 12 illustrates the training and fine-tuning of an LLM model 1202 on domain data, in accordance with some embodiments. Accordingly, the training and fine-tuning of the LLM model 1202, such as a Lintelligent™ LLM may be based on utilizing a plurality of training data. Further, in some embodiments, the plurality of training data may include an authentication and authorization data 1204, a security master data 1206, an investment book of record data 1208, a reference data 1210, a fundamental investment data 1212, and a market data 1214.

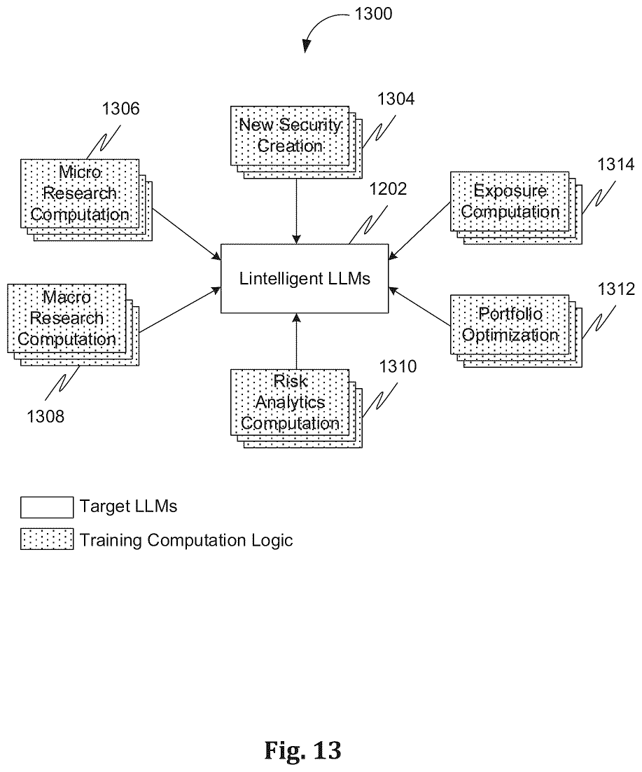

FIG. 13 illustrates the training and fine-tuning of an LLM model 1202 on domain computation logic, in accordance with some embodiments. Accordingly, the training and fine-tuning of the LLM model 1202, such as a Lintelligent™ LLM may be based on utilizing a plurality of training computational logic. Further, in some embodiments, the plurality of training computational logic may include new security creation 1304, micro research computation 1306, macro research computation 1308, risk analytics computation 1310, portfolio optimization 1312, and exposure computation 1314.

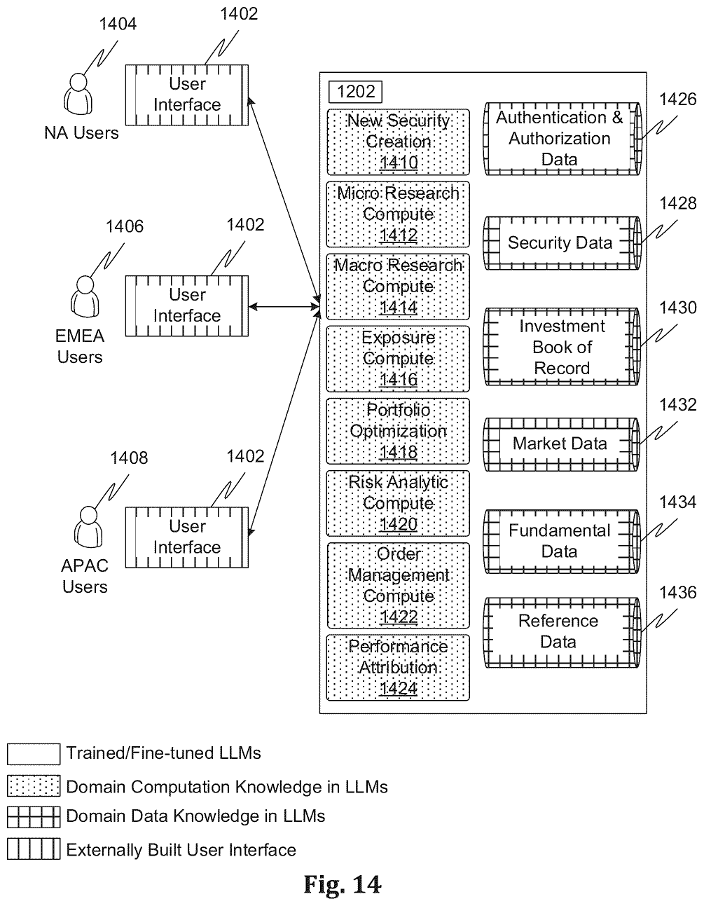

FIG. 14 illustrates a post-training of the LLM model 1202, in accordance with some embodiments. Accordingly, the LLM model 1202 may be associated with a user interface 1402 for allowing a plurality of users to interact with the user interface 1402. Further, in some embodiments, the plurality of users may include NA users 1404, EMEA users 1406, and APAC users 1408. Further, the LLM model 1202 may include a plurality of domain computation knowledge. Further, in some embodiments, the plurality of domain computation knowledge may include new security creation 1410, micro research compute 1412, macro research compute 1414, exposure compute 1416, portfolio optimization 1418, risk analytic compute 1420, order management compute 1422, and performance compute 1424. Further, the LLM model 1202 may include a plurality of domain data knowledge. Further, in some embodiments, the plurality of domain data knowledge may include an authentication and authorization data 1426, a security data 1428, an investment book of records 1430, a market data 1432, a fundamental data 1434, and a reference data 1436.

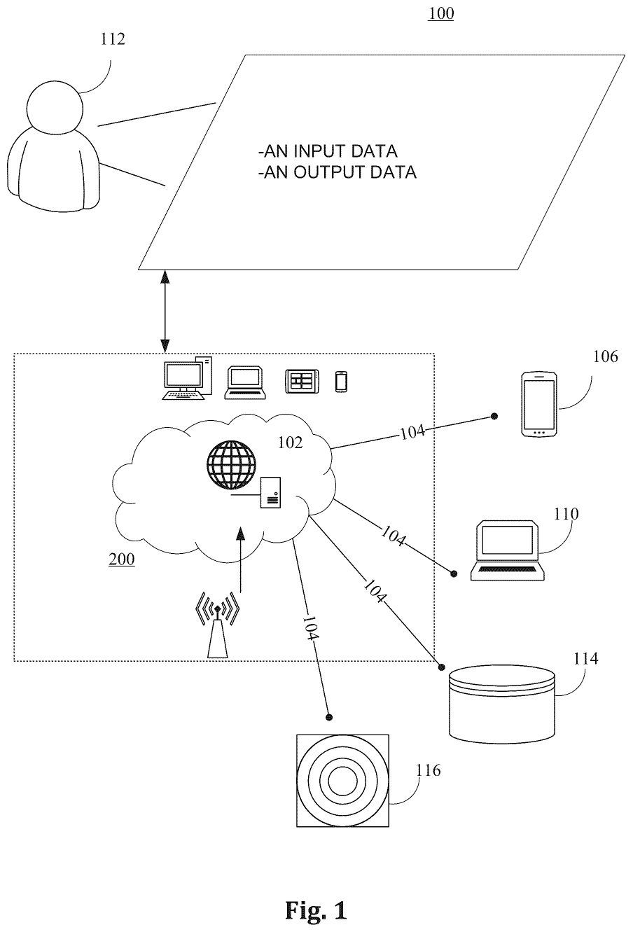

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

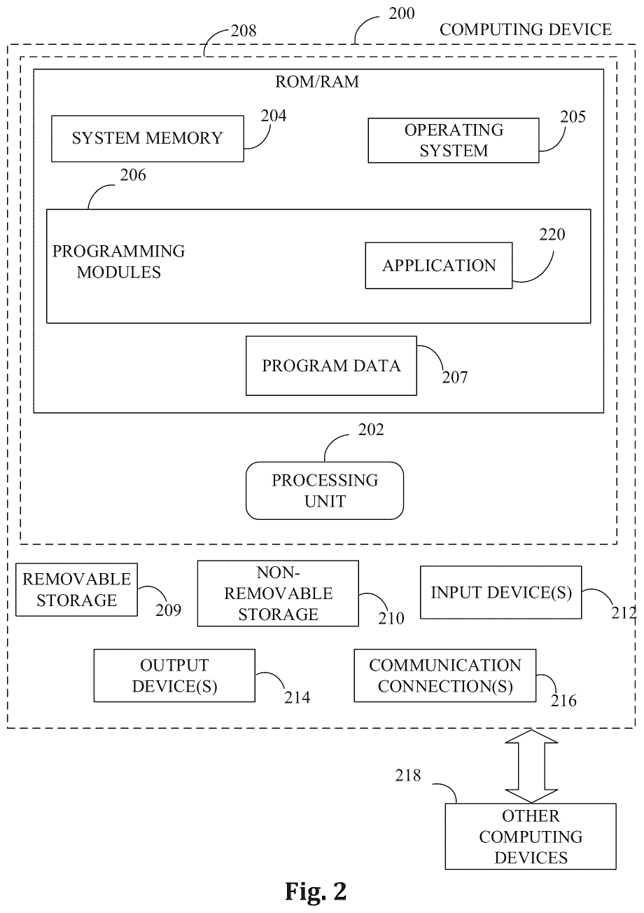

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module and, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

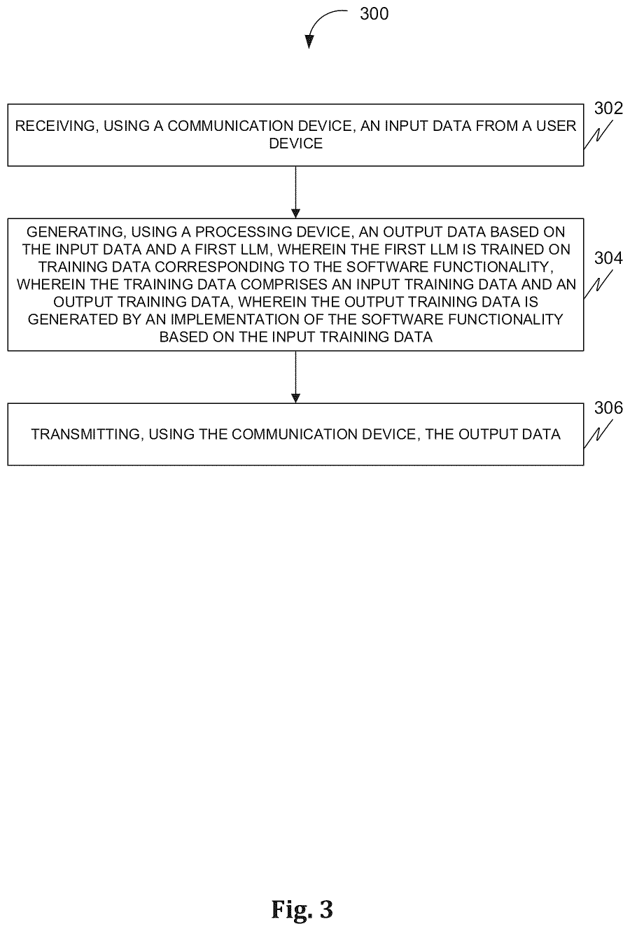

FIG. 3 illustrates a flowchart of a method 300 of facilitating provisioning of a software functionality, in accordance with some embodiments.

Accordingly, the method 300 may include a step 302 of receiving, using a communication device 602, an input data from a user device.

In some embodiments, the communication device 602 may be a hardware device which may be configured to one or more of transmit and receive a data. In some embodiments, the communication device 602 may be configured to one or more of transmit and receive the data wirelessly.

In some embodiments, the input data corresponds to one or more of an engineering domain, a finance domain, a medical domain, an education domain, and an enterprise domain.

In some embodiments, the user device includes one or more of a computer, a smart device, a server, and a cloud infrastructure. In some embodiments, the user device may be associated with a user. Further, the user includes one or more of a NA user, an EMEA user, and an APAC user.

Further, the method 300 may include a step 304 of generating, using a processing device 604, an output data based on the input data and a first LLM.

In some embodiments, the processing device 604 may be an electronic device which may be configured to execute a set of instructions.

In some embodiments, the first LLM includes one or more of a publically available LLM and a proprietary LLM. In some embodiments, the first LLM includes a pre-trained LLM. Further, the training of the first LLM includes fine-tuning of the pre-trained LLM. In some embodiments, the fine-tuning of the pre-trained LLM may be based on the input data. In some embodiments, the fine-tuning of the pre-trained LLM may be continuous. In some embodiments, the first LLM model includes a natural language processing algorithm.

In some embodiments, the input data may be associated with a prompt language associated with the first LLM. Further, the prompt language corresponds to the training data. In some embodiments, the prompt language includes one or more of a semantic construct and a meaning associated with the software functionality.

Further, the first LLM may be trained on training data corresponding to the software functionality.

In some embodiments, the receiving of the training data may be based on retrieving, using the processing device 604, the training data from a one or more of a storage device 702, and a database.

Further, the training data includes an input training data and an output training data. Further, the output training data may be generated by an implementation of the software functionality based on the input training data. Further, the method 300 may include a step 306 of transmitting, using the communication device 602, the output data.

In some embodiments, the receiving of the input data may be in accordance with a domain specific prompt model. Further, the generating of the output data may be based on the domain specific prompt model. In some embodiments, the domain specific prompt model corresponds to one or more of a financial service data, healthcare industry data, and an education industry data.

In some embodiments, the first LLM may be based on a machine learning model. In some embodiments, the machine learning model includes a neural network. In some embodiments, the machine learning model may be one or more of a supervised learning model, an unsupervised learning model, a semi-supervised learning model, a self-supervised learning model, and a reinforcement learning model.

In some embodiments, each of the software functionality and the training data may be associated with a domain.

In some embodiments, the training data represents a domain characteristic associated with the domain. In some embodiments, the domain includes one or more of a financial domain, a healthcare domain, and an education domain. In some embodiments, the domain characteristic includes one or more of an indication of a sensitive data and an action performed on the sensitive data. In some embodiments, the action includes one or more of anonymization and encryption operation.

In some embodiments, the method 300 may further include training, using the processing device 604, the first LLM.

In some embodiments, the method 300 may further include retrieving, using a storage device 702, a database data from a vector database. Further, the generating of the output data may be further based on the database data.

In some embodiments, the method 300 may further include analyzing, using the processing device 604, the input data. Further, the retrieving of the database data may be based on the analysis.

In some embodiments, the method 300 may further include generating, using the processing device 604, an embedding based on the database data. Further, the embedding may be generated based on an embedding model.

In some embodiments, the software functionality corresponds to a database management system.

In some embodiments, the software functionality corresponds to one or more of a front-end functionality and a backend functionality.

In some embodiments, the training of the first LLM includes tuning, using the processing device 604, a computation logic associated with a domain. Further, the generation of the output data may be based on the computation logic.

In some embodiments, the computation logic may be associated with a data processing flow. Further, the generation of the output may be based on the data processing flow.

In some embodiments, the method 300 may further include retrieving, using a storage device 702, a graph database data from a graph database. Further, the generating of the output data may be further based on the graph database data.

Further, in some embodiments, the method 300 further may include a step of generating, using the processing device 604, an interactive GUI comprising two or more interactive elements corresponding to an each of two or more prompts.

In some embodiments, the two or more interactive elements includes one or more of an click, a double click, a selection operation, a drag operation, a drop operation, and a zoom operation.

Further, the generation of the output data may be based on the each of the two or more prompts. Further, in some embodiments, the method 300 may include a step of transmitting, using the communication device 602, the interactive GUI to the user device. Further, the user device includes a user presentation device, a user input device, and a user communication device. Further, the user presentation may be configured to present the interactive GUI. Further, the input device may be configured to receive an indication corresponding to an interactive element of the two or more interactive elements from a user based on the presenting of the interactive GUI. Further, the user communication device may be configured to transmit the indication to the communication device 602. Further, in some embodiments, the method 300 further may include a step of receiving, using the communication device 602, the indication from the user device. Further, the generation of the output data may be based on the interactive element corresponding to the indication.

In some embodiments, the method 300 may further include retrieving, using a processing device 604, the first LLM from one or more of a storage device 702 and a database associated with an LLM provider.

In some embodiments, the method 300 may further include generating, using the processing device 604, an access control data based on the training data. Further, the generation of the output data may be based on the access control data.

In some embodiments, the access control data may be associated with one or more authorization and authentication of the user. In some embodiments, the access control may be associated with a guideline associated with a relevant agencies.

Further, in some embodiments, the method 300 further may include a step of receiving, using the communication device 602, the training data from one or more of the user device, a storage device 702, and a publically available database. Further, in some embodiments, the method 300 further may include a step of training, using the processing device 604, the first LLM based on the training data.

In some embodiments, the method 300 may further include generating, using the processing device 604, an API executable by the user device. Further, the executing of the API facilitates interaction between a user device and the communication device 602.

Further, in some embodiments, the method 300 further may include a step of receiving, using the communication device 602, a user interface data from the user device. Further, in some embodiments, the method 300 further may include a step of generating, using the processing device 604, a user interface based on the user interface data. Further, in some embodiments, the method 300 further may include a step of transmitting, using the communication device 602, the user interface to the user device. In some embodiments, the user device may be configured to present the user interface using a presentation device. Further, the receiving of the input data may be based on user interface. In some embodiments, the user interface data includes one or more of a design element, a design requirement, a UX data and an externally designed front end data.

In some embodiments, the method 300 may further include storing, using the storage device 702, a database data in a vector database based on the input data.

In some embodiments, the input data includes an indication of the database data.

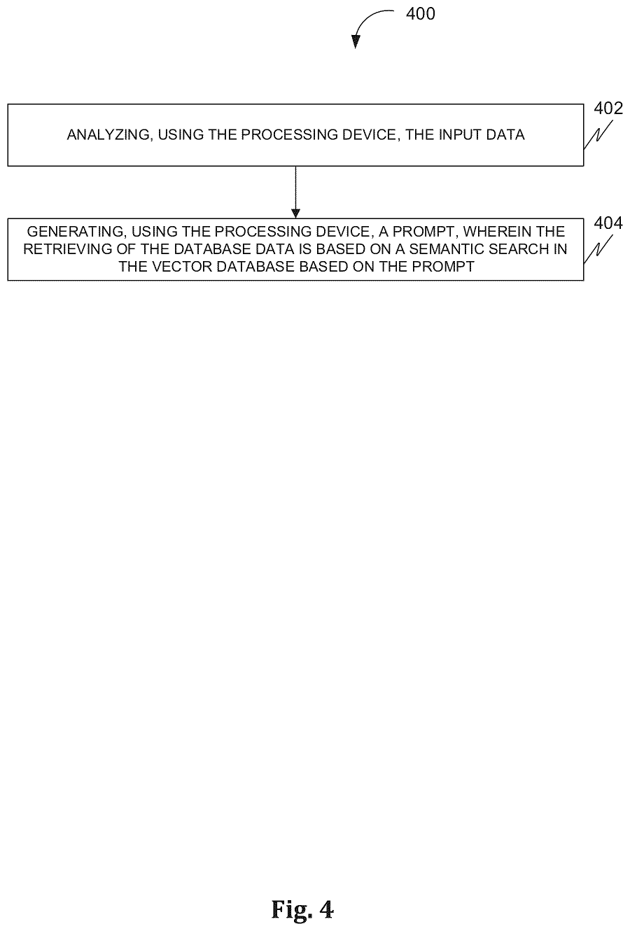

FIG. 4 illustrates a flowchart of a method 400 of facilitating provisioning of a software functionality including generating, using the processing device 604, a prompt, in accordance with some embodiments.

Further, in some embodiments, the method 400 further may include a step 402 of analyzing, using the processing device 604, the input data. Further, in some embodiments, the method 400 further may include a step 404 of generating, using the processing device 604, a prompt. Further, the retrieving of the database data may be based on a semantic search in the vector database based on the prompt.

In some embodiments, the prompt includes an embedding based on an embedding model. Further, the semantic search includes a contextual search based on the embedding.

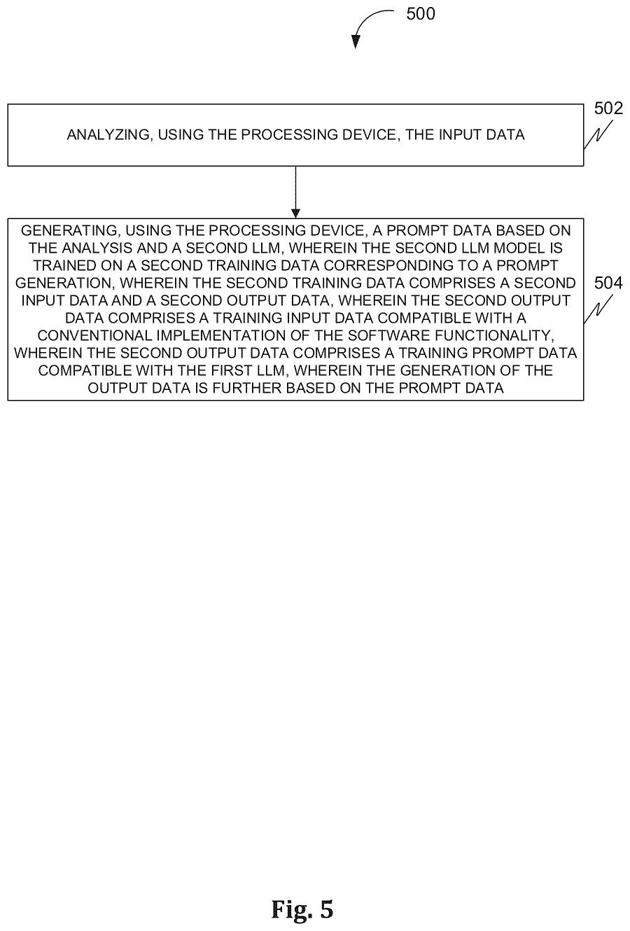

FIG. 5 illustrates a flowchart of a method 500 of facilitating provisioning of a software functionality including generating, using the processing device 604, a prompt data, in accordance with some embodiments.

Further, in some embodiments, the method 500 further may include a step 502 of analyzing, using the processing device 604, the input data. Further, in some embodiments, the method 500 further may include a step 504 of generating, using the processing device 604, a prompt data based on the analysis and a second LLM. Further, the second LLM model may be trained on a second training data corresponding to a prompt generation. Further, the second training data includes a second input data and a second output data. Further, the second output data includes a training input data compatible with a conventional implementation of the software functionality. Further, the second output data includes a training prompt data compatible with the first LLM. Further, the generation of the output data may be further based on the prompt data.

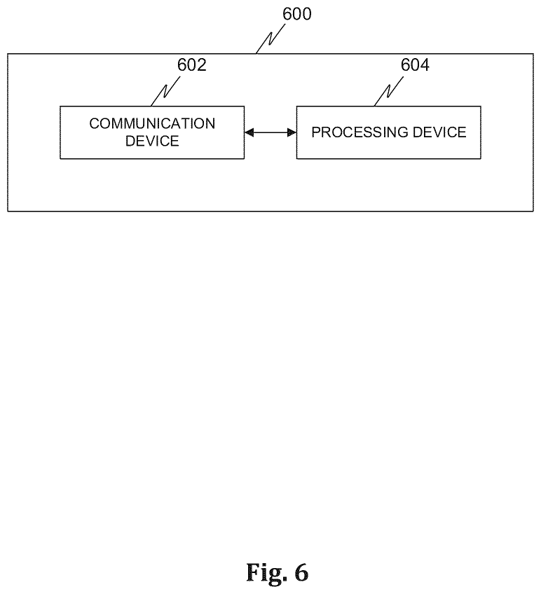

FIG. 6 illustrates a block diagram of a system 600 of facilitating provisioning of a software functionality, in accordance with some embodiments.

Accordingly, the system 600 may include a communication device 602. Further, the communication device 602 may be configured to receive an input data from a user device. Further, the communication device 602 may be configured to transmit an output data. Further, the system 600 may include a processing device 604 communicatively coupled with the communication device 602. Further, the processing device 604 may be configured to generate the output data based on the input data and a first LLM. Further, the first LLM may be trained on training data corresponding to the software functionality. Further, the training data includes an input training data and an output training data. Further, the output training data may be generated by an implementation of the software functionality based on the input training data.

In some embodiments, each of the software functionality and the training data may be associated with a domain.

In some embodiments, the processing device 604 may be further configured to train the first LLM.

Further, in some embodiments, the processing device 604 may be further configured to analyze the input data. Further, the processing device 604 may be further configured to generate a prompt. Further, the retrieving of the database data may be based on a semantic search in the vector database based on the prompt.

In some embodiments, the software functionality corresponds to one or more of a front-end functionality and a backend functionality.

Further, in some embodiments, the processing device 604 may be further configured to analyze the input data. Further, the processing device 604 may be further configured to generate a prompt data based on the analysis and a second LLM. Further, the second LLM model may be trained on a second training data corresponding to a prompt generation. Further, the second training data includes a second input data and a second output data. Further, the second output data includes a training input data compatible with a conventional implementation of the software functionality. Further, the second output data includes a training prompt data compatible with the first LLM. Further, the generation of the output data may be further based on the prompt data.

In some embodiments, the software functionality corresponds to a database management system.

In some embodiments, the training of the first LLM includes tuning, using the processing device 604, a computation logic associated with a domain. Further, the generation of the output data may be based on the computation logic.

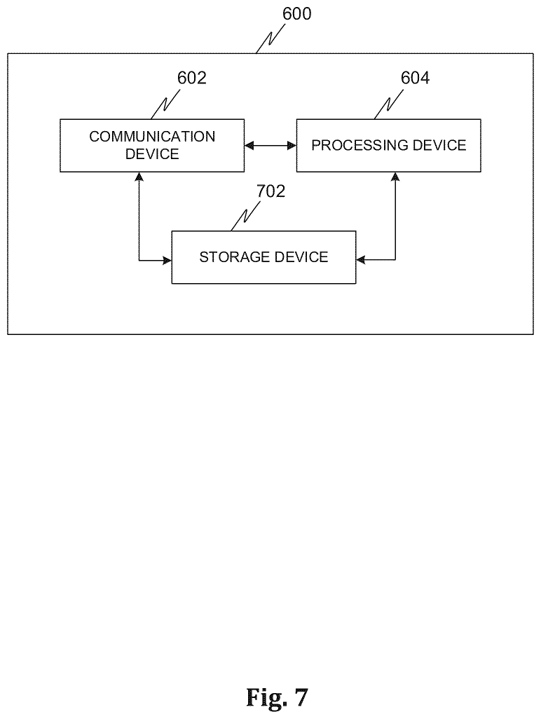

FIG. 7 illustrates a block diagram of the system 600 of facilitating provisioning of a software functionality, in accordance with some embodiments.

In some embodiments, the system 600 may further include a storage device 702 which may be configured to store a database data in a vector database based on the input data.

Further, in some embodiments, the storage device 702 may be further configured to retrieve a database data from a vector database. Further, the generating of the output data may be further based on the database data.

Although the invention has been explained in relation to its preferred embodiment, it is to be understood that many other possible modifications and variations can be made without departing from the spirit and scope of the invention as hereinafter claimed.

1. A method of facilitating provisioning of a software functionality, the method comprising:
receiving, using a communication device, an input data from a user device;
generating, using a processing device, an output data based on the input data and a first LLM, wherein the first LLM is trained on training data corresponding to the software functionality, wherein the training data comprises an input training data and an output training data, wherein the output training data is generated by an implementation of the software functionality based on the input training data; and
transmitting, using the communication device, the output data.

2. The method of claim 1, wherein each of the software functionality and the training data is associated with a domain.

3. The method of claim 1 further comprising training, using the processing device, the first LLM.

4. The method of claim 1 further comprising retrieving, using a storage device, a database data from a vector database, wherein the generating of the output data is further based on the database data.

5. The method of claim 4 further comprises:
analyzing, using the processing device, the input data;
generating, using the processing device, a prompt, wherein the retrieving of the database data is based on a semantic search in the vector database based on the prompt.

6. The method of claim 1 further comprising storing, using the storage device, a database data in a vector database based on the input data.

7. The method of claim 1, wherein the software functionality corresponds to at least one of a front-end functionality and a backend functionality.

8. The method of claim 1 further comprises:
analyzing, using the processing device, the input data;
generating, using the processing device, a prompt data based on the analysis and a second LLM, wherein the second LLM model is trained on a second training data corresponding to a prompt generation, wherein the second training data comprises a second input data and a second output data, wherein the second output data comprises a training input data compatible with a conventional implementation of the software functionality, wherein the second output data comprises a training prompt data compatible with the first LLM, wherein the generation of the output data is further based on the prompt data.

9. The method of claim 1, wherein the software functionality corresponds to a database management system.

10. The method of claim 1, wherein the training of the first LLM comprises tuning, using the processing device, a computation logic associated with a domain, wherein the generation of the output data is based on the computation logic.

11. A system for facilitating provisioning of a software functionality, the system comprising:
a communication device configured to:
receive an input data from a user device;
transmit an output data; and
a processing device communicatively coupled with the communication device, wherein the processing device is configured to:
generate the output data based on the input data and a first LLM, wherein the first LLM is trained on training data corresponding to the software functionality, wherein the training data comprises an input training data and an output training data, wherein the output training data is generated by an implementation of the software functionality based on the input training data.

12. The system of claim 11, wherein each of the software functionality and the training data is associated with a domain.

13. The system of claim 11, wherein the processing device is further configured to train the first LLM.

14. The system of claim 11 further comprises a storage device configured to retrieve a database data from a vector database, wherein the generating of the output data is further based on the database data.

15. The system of claim 14, wherein the processing device is further configured to:
analyze the input data;
generate a prompt, wherein the retrieving of the database data is based on a semantic search in the vector database based on the prompt.

16. The system of claim 11 further comprising a storage device configured to store a database data in a vector database based on the input data.

17. The system of claim 11, wherein the software functionality corresponds to at least one of a front-end functionality and a backend functionality.

18. The system of claim 11, wherein the processing device is further configured to:
analyze the input data;
generate a prompt data based on the analysis and a second LLM, wherein the second LLM model is trained on a second training data corresponding to a prompt generation, wherein the second training data comprises a second input data and a second output data, wherein the second output data comprises a training input data compatible with a conventional implementation of the software functionality, wherein the second output data comprises a training prompt data compatible with the first LLM, wherein the generation of the output data is further based on the prompt data.

19. The system of claim 11, wherein the software functionality corresponds to a database management system.

20. The system of claim 11, wherein the training of the first LLM comprises tuning, using the processing device, a computation logic associated with a domain, wherein the generation of the output data is based on the computation logic.
